(19) United States
(12) Patent Application Publication
(10) Pub. No.: US 2021/0012186 A1
(43) Pub. Date: Jan. 14, 2021

(54) SYSTEMS AND METHODS FOR PIPELINED PARALLELISM TO ACCELERATE DISTRIBUTED PROCESSING

(71) Applicant: Facebook Technologies, LLC, Menlo Park, CA (US)

(72) Inventors: Ganesh Venkatesh, San Jose, CA (US); Liangzhen Lai, Fremont, CA (US)

(73) Assignee: Facebook Technologies, LLC, Menlo Park, CA (US)

(21) Appl. No.: 16/509,252

(22) Filed: Jul. 11, 2019

(51) Int. Cl. G06N 3/063; G06N 3/04

(52) U.S. Cl. CPC G06N 3/0635; G06N 3/08; G06N 3/04

(57) ABSTRACT

Disclosed herein includes a system, a method, and a device for pipelined parallelism to accelerate distributed learning network graph. First data for a first layer of a neural network may be stored in memory. First circuitry including a first plurality of processing element (PE) circuits may read the first data from the memory and perform computation for the first layer of the neural network using the first data to generate second data. The first circuitry includes a plurality of buffers for outputting the generated second data as input to second circuitry to perform computation for a second layer of the neural network. The second circuitry includes a second plurality of PE circuits configured to perform computation for the second layer of the neural network using the second data.

### FIELD OF DISCLOSURE

The present disclosure is generally related to neural networks, including but not limited to systems and methods for pipelined parallelism in AI accelerators for neural networks.

### BACKGROUND

Machine learning is being implemented in various different computing environments including, for instance, computer vision, image processing, and so forth. Some machine learning systems may incorporate neural networks (e.g., artificial neural networks). However, such neural networks may be computationally expensive, both from a processing standpoint and from an energy efficiency standpoint.

### SUMMARY

Various embodiments disclosed herein are related to a device for pipelined parallelism to perform AI related processing for a neural network. The device includes memory (e.g., static random access memory) configured to store first data for a first layer of a neural network. The device includes first circuitry having a first plurality of processing element (PE) circuits configured to read the first data from the memory and to perform computation for the first layer of the neural network using the first data to generate second data. The first circuitry further includes a plurality of buffers (e.g., sequential and/or combinational logic or devices) configured to output the generated second data as input to second circuitry to perform computation for a second layer of the neural network. The second circuitry includes a second plurality of PE circuits configured to perform computation for the second layer of the neural network using the second data.

In some embodiments, the first plurality of PE circuits is configured to perform computation for at least one node of the neural network while the second plurality of PE circuits is performing computation for the second layer of the neural network. In some embodiments, the at least one node is from a third layer of the neural network or from the first layer of the neural network. In some embodiments, the plurality of buffers is configured to output the generated second data as input to the second circuitry by bypassing any transfer of the second data into or out of the memory. In some embodiments, the second plurality of PE circuits is further configured to use the second data to generate third data. In some embodiments, the second plurality of PE circuits is further configured to store the generated third data to the memory. In some embodiments, the second circuitry further includes a plurality of buffers configured to output the generated third data as input to third circuitry.

In some embodiments, the first data includes at least one of weight or activation information for the first layer of the neural network, and the second data includes at least one of weight or activation information for the second layer of the neural network. In some embodiments, the first plurality of PE circuits is configured to perform a convolution operation using the first data, and the second plurality of PE circuits is configured to perform dot-product operations using the second data. In some embodiments, the first circuitry and the second circuitry are formed on a same semiconductor device. In some embodiments, the plurality of buffers is configured with sufficient capacity to buffer the generated second data and output the generated second data to the second circuitry.

Various embodiments disclosed herein are related to a method for pipelined parallelism to perform AI related processing for a neural network. The method can include storing first data for a first layer of a neural network in a memory. The method can include reading, by a first plurality of processing element (PE) circuits, the first data from the memory. The method can include using, by the first plurality of PE circuits, the first data to perform computation for the first layer of the neural network to generate second data. The method can include providing, by a plurality of buffers of the first plurality of PE circuits, the generated second data as input to a second plurality of PE circuits to perform computation for a second layer of the neural network. The method can include using, by the second plurality of PE circuits, the second data to perform computation for the second layer of the neural network.

In some embodiments, the method includes performing, by the first plurality of PE circuits, computation for at least one node of the neural network while the second plurality of PE circuits is performing computation for the second layer of the neural network. In some embodiments, the at least one node is from a third layer of the neural network or from the first layer of the neural network. In some embodiments, the method includes providing, by the plurality of buffers, the generated second data as input to the second circuitry or plurality of PE circuits by bypassing any transfer of the second data into or out of the memory. In some embodiments, the method includes generating, by the second plurality of PE circuits, third data using the second data. In some embodiments, the method includes storing, by the second plurality of PE circuits, the generated third data to the memory. In some embodiments, the method includes providing, by a plurality of buffers of the second circuitry (e.g., buffers corresponding to the second plurality of PE circuits), the generated third data as input to third circuitry. In some embodiments, the first data comprises at least one of weight or activation information for the first layer of the neural network, and the second data comprises at least one of weight or activation information for the second layer of the neural network. In some embodiments, the method includes performing, by the first plurality of PE circuits, a convolution operation using the first data, and performing, by the second plurality of PE circuits, dot-product operations using the second data.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1A is a block diagram of an embodiment of a system for performing artificial intelligence (AI) related processing, according to an example implementation of the present disclosure.

FIG. 1B is a block diagrams of an embodiment of a device for performing artificial intelligence (AI) related processing, according to an example implementation of the present disclosure.

FIG. 1C is a block diagram of an embodiment of a device for performing artificial intelligence (AI) related processing, according to an example implementation of the present disclosure.

FIG. 1D shows a block diagram of a representative computing system, according to an example implementation of the present disclosure.

FIG. 2A is a block diagram of a device for pipelined parallelism to perform AI related processing for a neural network, according to an example implementation of the present disclosure.

FIG. 2B is a block diagram of a device for pipelined parallelism to perform AI related processing for a neural network, according to an example implementation of the present disclosure.

FIG. 2C is a flow chart illustrating a process for pipelined parallelism to perform AI related processing for a neural network, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments of the present invention below, the following descriptions of the sections of the specification and their respective contents may be helpful:
Section A describes an environment, system, configuration and/or other aspects useful for practicing or implementing an embodiment of the present systems, methods and devices; and
Section B describes embodiments of devices, systems and methods for pipelined parallelism to perform AI related processing for a neural network.

### A. Environment for Artificial Intelligence Related Processing

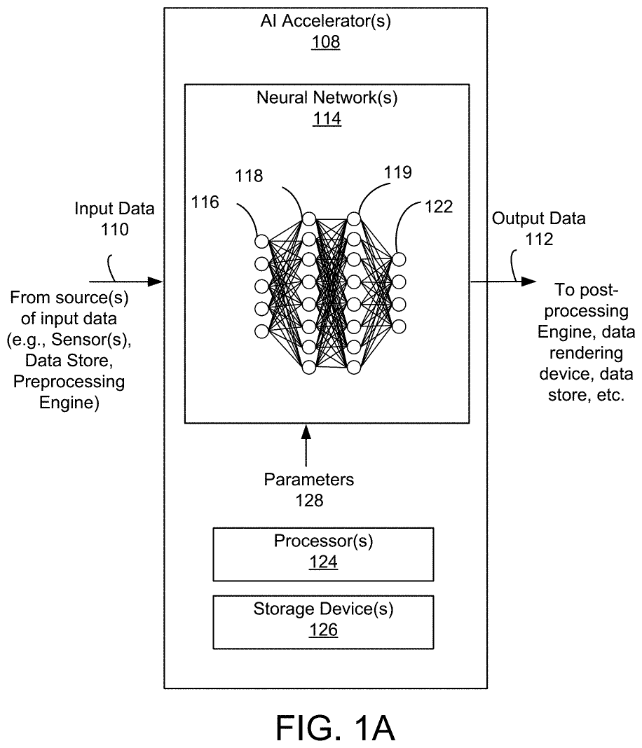

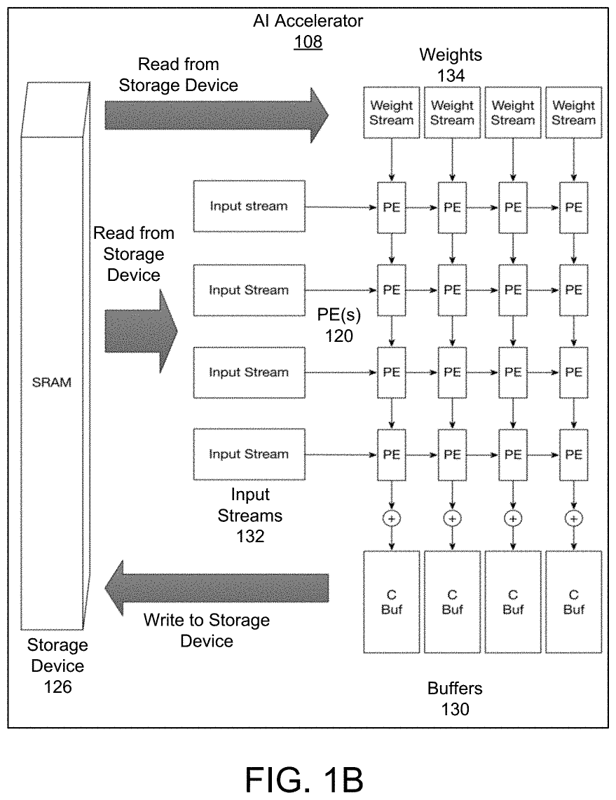

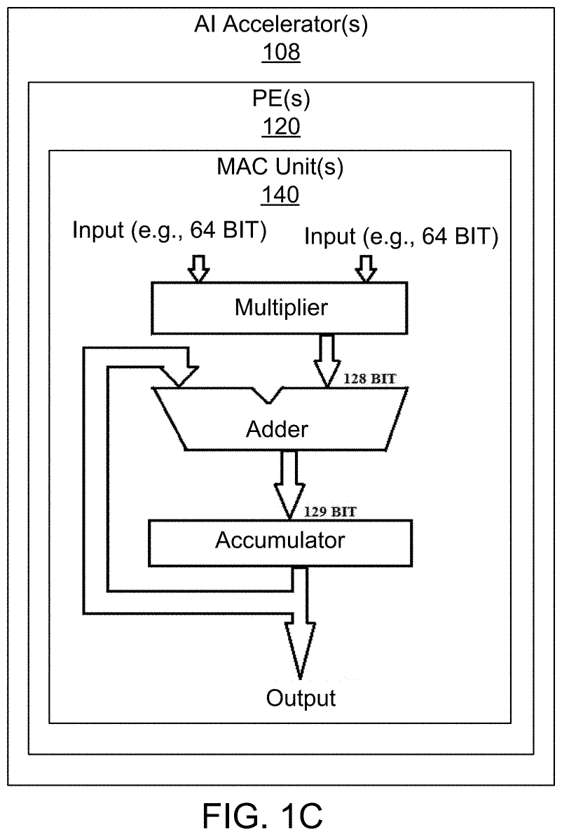

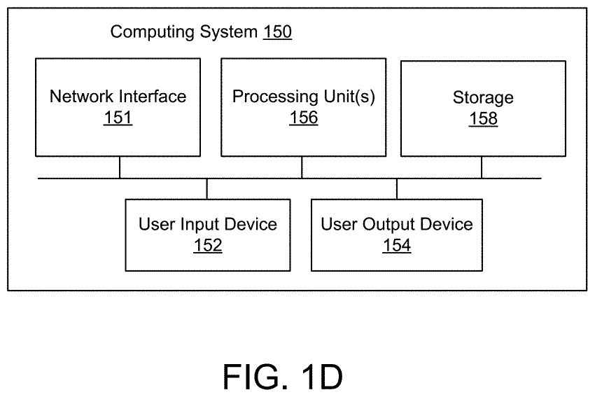

Prior to discussing the specifics of embodiments of systems, devices and/or methods in Section B, it may be helpful to discuss the environments, systems, configurations and/or other aspects useful for practicing or implementing certain embodiments of the systems, devices and/or methods. Referring now to FIG. 1A, an embodiment of a system for performing artificial intelligence (AI) related processing is depicted. In brief overview, the system includes one or more AI accelerators 108 that can perform AI related processing using input data 110. Although referenced as an AI accelerator 108, it is sometimes referred as a neural network accelerator (NNA), neural network chip or hardware, AI processor, AI chip, etc. The AI accelerator(s) 108 can perform AI related processing to output or provide output data 112, according to the input data 110 and/or parameters 128 (e.g., weight and/or bias information). An AI accelerator 108 can include and/or implement one or more neural networks 114 (e.g., artificial neural networks), one or more processor(s) 24 and/or one or more storage devices 126.

Each of the above-mentioned elements or components is implemented in hardware, or a combination of hardware and software. For instance, each of these elements or components can include any application, program, library, script, task, service, process or any type and form of executable instructions executing on hardware such as circuitry that can include digital and/or analog elements (e.g., one or more transistors, logic gates, registers, memory devices, resistive elements, conductive elements, capacitive elements).

The input data 110 can include any type or form of data for configuring, tuning, training and/or activating a neural network 114 of the AI accelerator(s) 108, and/or for processing by the processor(s) 124. The neural network 114 is sometimes referred to as an artificial neural network (ANN). Configuring, tuning and/or training a neural network can refer to or include a process of machine learning in which training data sets (e.g., as the input data 110) such as historical data are provided to the neural network for processing. Tuning or configuring can refer to or include training or processing of the neural network 114 to allow the neural network to improve accuracy. Tuning or configuring the neural network 114 can include, for example, designing, forming, building, synthesizing and/or establishing the neural network using architectures that have proven to be successful for the type of problem or objective desired for the neural network 114. In some cases, the one or more neural networks 114 may initiate at a same or similar baseline model, but during the tuning, training or learning process, the results of the neural networks 114 can be sufficiently different such that each neural network 114 can be tuned to process a specific type of input and generate a specific type of output with a higher level of accuracy and reliability as compared to a different neural network that is either at the baseline model or tuned or trained for a different objective or purpose. Tuning the neural network 114 can include setting different parameters 128 for each neural network 114, fine-tuning the parameters 114 differently for each neural network 114, or assigning different weights (e.g., hyperparameters, or learning rates), tensor flows, etc. Thus, setting appropriate parameters 128 for the neural network(s) 114 based on a tuning or training process and the objective of the neural network(s) and/or the system, can improve performance of the overall system.

A neural network 114 of the AI accelerator 108 can include any type of neural network including, for example, a convolution neural network (CNN), deep convolution network, a feed forward neural network (e.g., multilayer perceptron (MLP)), a deep feed forward neural network, a radial basis function neural network, a Kohonen self-organizing neural network, a recurrent neural network, a modular neural network, a long/short term memory neural network, etc. The neural network(s) 114 can be deployed or used to perform data (e.g., image, audio, video) processing, object or feature recognition, recommender functions, data or image classification, data (e.g., image) analysis, etc., such as natural language processing.

As an example, and in one or more embodiments, the neural network 114 can be configured as or include a convolution neural network. The convolution neural network can include one or more convolution cells (or pooling layers) and kernels, that can each serve a different purpose. The convolution neural network can include, incorporate and/or use a convolution kernel (sometimes simply referred as “kernel”). The convolution kernel can process input data, and the pooling layers can simplify the data, using, for example, non-linear functions such as a max, thereby reducing unnecessary features. The neural network 114 including the convolution neural network can facilitate image, audio or any data recognition or other processing. For example, the input data 110 (e.g., from a sensor) can be passed to convolution layers of the convolution neural network that form a funnel, compressing detected features in the input data 110. The first layer of the convolution neural network can detect first characteristics, the second layer can detect second characteristics, and so on.

The convolution neural network can be a type of deep, feed-forward artificial neural network configured to analyze visual imagery, audio information, and/or any other type or form of input data 110. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other data classification/processing algorithms, the convolution neural network can automatically learn the filters that may be hand-engineered for other data classification/processing algorithms, thereby improving the efficiency associated with configuring, establishing or setting up the neural network 114, thereby providing a technical advantage relative to other data classification/processing techniques.

The neural network 114 can include an input layer 116 and an output layer 122, of neurons or nodes. The neural network 114 can also have one or more hidden layers 118, 119 that can include convolution layers, pooling layers, fully connected layers, and/or normalization layers, of neurons or nodes. In a neural network 114, each neuron can receive input from some number of locations in the previous layer. In a fully connected layer, each neuron can receive input from every element of the previous layer.

Each neuron in a neural network 114 can compute an output value by applying some function to the input values coming from the receptive field in the previous layer. The function that is applied to the input values is specified by a vector of weights and a bias (typically real numbers). Learning (e.g., during a training phase) in a neural network 114 can progress by making incremental adjustments to the biases and/or weights. The vector of weights and the bias can be called a filter and can represent some feature of the input (e.g., a particular shape). A distinguishing feature of convolutional neural networks is that many neurons can share the same filter. This reduces memory footprint because a single bias and a single vector of weights can be used across all receptive fields sharing that filter, rather than each receptive field having its own bias and vector of weights.

For example, in a convolution layer, the system can apply a convolution operation to the input layer 116, passing the result to the next layer. The convolution emulates the response of an individual neuron to input stimuli. Each convolutional neuron can process data only for its receptive field. Using the convolution operation can reduce the number of neurons used in the neural network 114 as compared to a fully connected feedforward neural network. Thus, the convolution operation can reduce the number of free parameters, allowing the network to be deeper with fewer parameters. For example, regardless of an input data (e.g., image data) size, tiling regions of size 5×5, each with the same shared weights, may use only 25 learnable parameters. In this way, the first neural network 114 with a convolution neural network can resolve the vanishing or exploding gradients problem in training traditional multi-layer neural networks with many layers by using backpropagation.

The neural network 114 (e.g., configured with a convolution neural network) can include one or more pooling layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer.

The neural network 114 (e.g., configured with a convolution neural network) can include fully connected layers. Fully connected layers can connect every neuron in one layer to every neuron in another layer. The neural network 114 can be configured with shared weights in convolutional layers, which can refer to the same filter being used for each receptive field in the layer, thereby reducing a memory footprint and improving performance of the first neural network 114.

The hidden layers 118, 119 can include filters that are tuned or configured to detect information based on the input data (e.g., sensor data, from a virtual reality system for instance). As the system steps through each layer in the neural network 114 (e.g., convolution neural network), the system can translate the input from a first layer and output the transformed input to a second layer, and so on. The neural network 114 can include one or more hidden layers 118, 119 based on the type of object or information being detected, processed and/or computed, and the type of input data 110.

In some embodiments, the convolutional layer is the core building block of a neural network 114 (e.g., configured as a CNN). The layer's parameters 128 can include a set of learnable filters (or kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the neural network 114 can learn filters that activate when it detects some specific type of feature at some spatial position in the input. Stacking the activation maps for all filters along the depth dimension forms the full output volume of the convolution layer. Every entry in the output volume can thus also be interpreted as an output of a neuron that looks at a small region in the input and shares parameters with neurons in the same activation map. In a convolutional layer, neurons can receive input from a restricted subarea of the previous layer. Typically, the subarea is of a square shape (e.g., size 5 by 5). The input area of a neuron is called its receptive field. So, in a fully connected layer, the receptive field is the entire previous layer. In a convolutional layer, the receptive area can be smaller than the entire previous layer.

The first neural network 114 can be trained to detect, classify, segment and/or translate input data 110 (e.g., by detecting or determining the probabilities of objects, events, words and/or other features, based on the input data 110). For example, the first input layer 116 of neural network 114 can receive the input data 110, process the input data 110 to transform the data to a first intermediate output, and forward the first intermediate output to a first hidden layer 118. The first hidden layer 118 can receive the first intermediate output, process the first intermediate output to transform the first intermediate output to a second intermediate output, and forward the second intermediate output to a second hidden layer 119. The second hidden layer 119 can receive the second intermediate output, process the second intermediate output to transform the second intermediate output to a third intermediate output, and forward the third intermediate output to an output layer 122 for example. The output layer 122 can receive the third intermediate output, process the third intermediate output to transform the third intermediate output to output data 112, and forward the output data 112 (e.g., possibly to a post-processing engine, for rendering to a user, for storage, and so on). The output data 112 can include object detection data, enhanced/translated/augmented data, a recommendation, a classification, and/or segmented data, as examples.

Referring again to FIG. 1A, the AI accelerator 108 can include one or more storage devices 126. A storage device 126 can be designed or implemented to store, hold or maintain any type or form of data associated with the AI accelerator(s) 108. For example, the data can include the input data 110 that is received by the AI accelerator(s) 108, and/or the output data 112 (e.g., before being output to a next device or processing stage). The data can include intermediate data used for, or from any of the processing stages of a neural network(s) 114 and/or the processor(s) 124. The data can include one or more operands for input to and processing at a neuron of the neural network(s) 114, which can be read or accessed from the storage device 126. For example, the data can include input data, weight information and/or bias information, activation function information, and/or parameters 128 for one or more neurons (or nodes) and/or layers of the neural network(s) 114, which can be stored in and read or accessed from the storage device 126. The data can include output data from a neuron of the neural network(s) 114, which can be written to and stored at the storage device 126. For example, the data can include activation data, refined or updated data (e.g., weight information and/or bias information from a training phase for example, activation function information, and/or other parameters 128) for one or more neurons (or nodes) and/or layers of the neural network(s) 114, which can be transferred or written to, and stored in the storage device 126.

In some embodiments, the AI accelerator 108 can include one or more processors 124. The one or more processors 124 can include any logic, circuitry and/or processing component (e.g., a microprocessor) for pre-processing input data for any one or more of the neural network(s) 114 or AI accelerator(s) 108, and/or for post-processing output data for any one or more of the neural network(s) 114 or AI accelerator(s) 108. The one or more processors 124 can provide logic, circuitry, processing component and/or functionality for configuring, controlling and/or managing one or more operations of the neural network(s) 114 or AI accelerator(s) 108. For instance, a processor 124 may receive data or signals associated with a neural network 114 to control or reduce power consumption (e.g., via clock-gating controls on circuitry implementing operations of the neural network 114). As another example, a processor 124 may partition and/or re-arrange data for separate processing (e.g., at various components of an AI accelerator 108, in parallel for example), sequential processing (e.g., on the same component of an AI accelerator 108, at different times or stages), or for storage in different memory slices of a storage device, or in different storage devices. In some embodiments, the processor(s) 124 can configure a neural network 114 to operate for a particular context, provide a certain type of processing, and/or to address a specific type of input data, e.g., by identifying, selecting and/or loading specific weight, activation function and/or parameter information to neurons and/or layers of the neural network 114.

In some embodiments, the AI accelerator 108 is designed and/or implemented to handle or process deep learning and/or AI workloads. For example, the AI accelerator 108 can provide hardware acceleration for artificial intelligence applications, including artificial neural networks, machine vision and machine learning. The AI accelerator 108 can be configured for operation to handle robotics related, internet of things (IoT) related, and other data-intensive or sensor-driven tasks. The AI accelerator 108 may include a multi-core or multiple processing element (PE) design, and can be incorporated into various types and forms of devices such as artificial reality (e.g., virtual, augmented or mixed reality) systems, smartphones, tablets, and computers. Certain embodiments of the AI accelerator 108 can include or be implemented using at least one digital signal processor (DSP), co-processor, microprocessor, computer system, heterogeneous computing configuration of processors, graphics processing unit (GPU), field-programmable gate array (FPGA), and/or application-specific integrated circuit (ASIC). The AI accelerator 108 can be a transistor based, semiconductor based and/or a quantum computing based device.

Referring now to FIG. 1B, an example embodiment of a device for performing AI related processing is depicted. In brief overview, the device can include or correspond to an AI accelerator 108, e.g., with one or more features described above in connection with FIG. 1A. The AI accelerator 108 can include one or more storage devices 126 (e.g., memory such as a static random-access memory (SRAM) device), one or more buffers, a plurality or array of processing element (PE) circuits, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In a neural network 114 (e.g., artificial neural network) implemented in the AI accelerator 108, neurons can take various forms and can be referred to as processing elements (PEs) or PE circuits. The neuron can be implemented as a corresponding PE circuit, and the processing/activation that can occur at the neuron can be performed at the PE circuit. The PEs are connected into a particular network pattern or array, with different patterns serving different functional purposes. The PE in an artificial neural network operate electrically (e.g., in the embodiment of a semiconductor implementation), and may be either analog, digital, or a hybrid. To parallel the effect of a biological synapse, the connections between PEs can be assigned multiplicative weights, which can be calibrated or “trained” to produce the proper system output.

A PE can be defined in terms of the following equations (e.g., which represent a McCulloch-Pitts model of a neuron):

ζ=Σᵢwᵢxᵢ (1)

y=σ(ζ) (2)

Where ζ is the weighted sum of the inputs (e.g., the inner product of the input vector and the tap-weight vector), and σ(ζ) is a function of the weighted sum. Where the weight and input elements form vectors w and x, the ζ weighted sum becomes a simple dot product:

ζ=w·x (3)

This may be referred to as either the activation function (e.g., in the case of a threshold comparison) or a transfer function. In some embodiments, one or more PEs can be referred to as a dot product engine. The input (e.g., input data 110) to the neural network 114, x, can come from an input space and the output (e.g., output data 112) are part of the output space. For some neural networks, the output space Y may be as simple as {0, 1}, or it may be a complex multi-dimensional (e.g., multiple channel) space (e.g., for a convolutional neural network). Neural networks tend to have one input per degree of freedom in the input space, and one output per degree of freedom in the output space.

In some embodiments, the PEs can be arranged and/or implemented as a systolic array. A systolic array can be a network (e.g., a homogeneous network) of coupled data processing units (DPUs) such as PEs, called cells or nodes. Each node or PE can independently compute a partial result as a function of the data received from its upstream neighbors, can store the result within itself and can pass the result downstream for instance. The systolic array can be hardwired or software configured for a specific application. The nodes or PEs can be fixed and identical, and interconnect of the systolic array can be programmable. Systolic arrays can rely on synchronous data transfers.

Referring again to FIG. 1B, the input x to a PE 120 can be part of an input stream 132 that is read or accessed from a storage device 126 (e.g., SRAM). An input stream 132 can be directed to one row (horizontal bank or group) of PEs, and can be shared across one or more of the PEs, or partitioned into data portions (overlapping or non-overlapping data portions) as inputs for respective PEs. Weights 134 (or weight information) in a weight stream (e.g., read from the storage device 126) can be directed or provided to a column (vertical bank or group) of PEs. Each of the PEs in the column may share the same weight 134 or receive a corresponding weight 134. The input and/or weight for each target PE can be directly routed (e.g., from the storage device 126) to the target PE (e.g., without passing through other PE(s)), or can be routed through one or more PEs (e.g., along a row or column of PEs) to the target PE. The output of each PE can be routed directly out of the PE array (e.g., without passing through other PE(s)), or can be routed through one or more PEs (e.g., along a column of PEs) to exit the PE array. The outputs of each column of PEs can be summed or added at an adder circuitry of the respective column, and provided to a buffer 130 for the respective column of PEs. The buffer(s) 130 can provide, transfer, route, write and/or store the received outputs to the storage device 126. In some embodiments, the outputs (e.g., activation data from one layer of the neural network) that are stored by the storage device 126 can be retrieved or read from the storage device 126, and be used as inputs to the array of PEs 120 for processing (of a subsequent layer of the neural network) at a later time. In certain embodiments, the outputs that are stored by the storage device 126 can be retrieved or read from the storage device 126 as output data 112 for the AI accelerator 108.

Referring now to FIG. 1C, one example embodiment of a device for performing AI related processing is depicted. In brief overview, the device can include or correspond to an AI accelerator 108, e.g., with one or more features described above in connection with FIGS. 1A and 1B. The AI accelerator 108 can include one or more PEs 120, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In some embodiments, a PE 120 can include one or more multiply-accumulate (MAC) units or circuits 140. One or more PEs can sometimes be referred to (singly or collectively) as a MAC engine. A MAC unit is configured to perform multiply-accumulate operation(s). The MAC unit can include a multiplier circuit, an adder circuit and/or an accumulator circuit. The multiply-accumulate operation computes the product of two numbers and adds that product to an accumulator. The MAC operation can be represented as follows, in connection with an accumulator operand a, and inputs b and c:

a←a+(b×c) (4)

In some embodiments, a MAC unit 140 may include a multiplier implemented in combinational logic followed by an adder (e.g., that includes combinational logic) and an accumulator register (e.g., that includes sequential and/or combinational logic) that stores the result. The output of the accumulator register can be fed back to one input of the adder, so that on each clock cycle, the output of the multiplier can be added to the accumulator register.

As discussed above, a MAC unit 140 can perform both multiply and addition functions. The MAC unit 140 can operate in two stages. The MAC unit 140 can first compute the product of given numbers (inputs) in a first stage, and forward the result for the second stage operation (e.g., addition and/or accumulate). An n-bit MAC unit 140 can include an n-bit multiplier, 2n-bit adder, and 2n-bit accumulator. An array or plurality of MAC units 140 (e.g., in PEs) can be arranged in a systolic array, for parallel integration, convolution, correlation, matrix multiplication, data sorting, and/or data analysis tasks.

Various systems and/or devices described herein can be implemented in a computing system. FIG. 1D shows a block diagram of a representative computing system 150. In some embodiments, the system of FIG. 1A can form at least part of the processing unit(s) 156 (or processors 156) of the computing system 150. Computing system 150 can be implemented, for example, as a device (e.g., consumer device) such as a smartphone, other mobile phone, tablet computer, wearable computing device (e.g., smart watch, eyeglasses, head mounted display), desktop computer, laptop computer, or implemented with distributed computing devices. The computing system 150 can be implemented to provide VR, AR, MR experience. In some embodiments, the computing system 150 can include conventional, specialized or custom computer components such as processors 156, storage device 158, network interface 151, user input device 152, and user output device 154.

Network interface 151 can provide a connection to a local/wide area network (e.g., the Internet) to which network interface of a (local/remote) server or back-end system is also connected. Network interface 151 can include a wired interface (e.g., Ethernet) and/or a wireless interface implementing various RF data communication standards such as Wi-Fi, Bluetooth, or cellular data network standards (e.g., 3G, 4G, 5G, LTE, etc.).

User input device 152 can include any device (or devices) via which a user can provide signals to computing system 150; computing system 150 can interpret the signals as indicative of particular user requests or information. User input device 152 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 154 can include any device via which computing system 150 can provide information to a user. For example, user output device 154 can include a display to display images generated by or delivered to computing system 150. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. User output devices 154 can be provided in addition to or instead of a display. Examples include indicator lights, speakers, tactile “display” devices, printers, and so on.

Some implementations include electronic components, such as microprocessors, storage and memory that store computer program instructions in a non-transitory computer readable storage medium. Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 156 can provide various functionality for computing system 150, including any of the functionality described herein as being performed by a server or client, or other functionality associated with message management services.

It will be appreciated that computing system 150 is illustrative and that variations and modifications are possible. Computer systems used in connection with the present disclosure can have other capabilities not specifically described here. Further, while computing system 150 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### B. Methods and Devices for Pipelined Parallelism to Perform AI Related Processing for a Neural Network

Disclosed herein are embodiments of a system, a method, and a device for pipelined parallelism to perform AI related processing for a neural network, such as to accelerate processing in a distributed learning network graph. In some aspects, this disclosure is directed to implementing neural network accelerators (NNAs) that support pipelined parallelism across at least two layers of a neural network. As described above, a neural network may include two or more layers. In some implementations, output data (or activation data) computed for a first layer of the neural network is written from local buffers into memory (e.g., SRAM). The output data in memory are subsequently read from the memory and provided (e.g., as input operands) into another (or the same) MAC engine or NNA (e.g., dot-product engine or matrix multiply accelerator, comprising a plurality of PEs) for computation for a second layer of the neural network. These memory read and write operations can be frequent, involve significant amount of data transfer, and result in significant power consumption (e.g., on a chip, in a head mounted display unit for instance).

The present technical solution can implement AI accelerator chaining or pipelining to send the first layer output data from local buffers of a first AI accelerator 108 (e.g., first array of PEs 120) directly to a second AI accelerator 108 (e.g., second array of PEs), hence bypassing the memory read and write operations. Such AI accelerator chaining or pipelining can for example support layer-types whose first-layer output data can fit within the local buffers (having sufficient buffering capacity, without requiring additional storage from memory) for second layer processing. In some embodiments, rather than implementing a single AI accelerator 108 with potentially un-utilized/under-utilized PEs, two or more smaller (but more efficiently utilized) AI accelerators 108 can be implemented in a chained configuration using the same or similar total number of PE circuits for example.

According to the implementations described herein, the present technical solution can support pipelined parallelism where operations for two (or more) layers of a neural network are run or executed in parallel and also in a pipeline (such that the output of one layer can be fed directly into the next layer). The present technical solution thus can provide better performance through parallel processing, and can bypass reading and writing operations to memory (e.g., between layers of a neural network), thereby providing improvements to processing throughput and/or energy efficiency. The present technical solution can allow distributed learning-based applications to be deployed on such a multi-accelerator device which provides the benefit of efficient multi-layer machine learning running in parallel on customized, energy-efficient hardware. According to the implementations of the technical solution, the layers of the neural network are pipelined or chained so that one layer can send its output directly to the next layer as input, which can save power by avoiding memory-related operations and/or traffic. Energy savings can also be realized which are proportional to the reduction in computations in utilizing smaller sets of PEs appropriate for a certain application (instead of a larger set of PEs) to perform AI related processing (e.g., group convolutions).

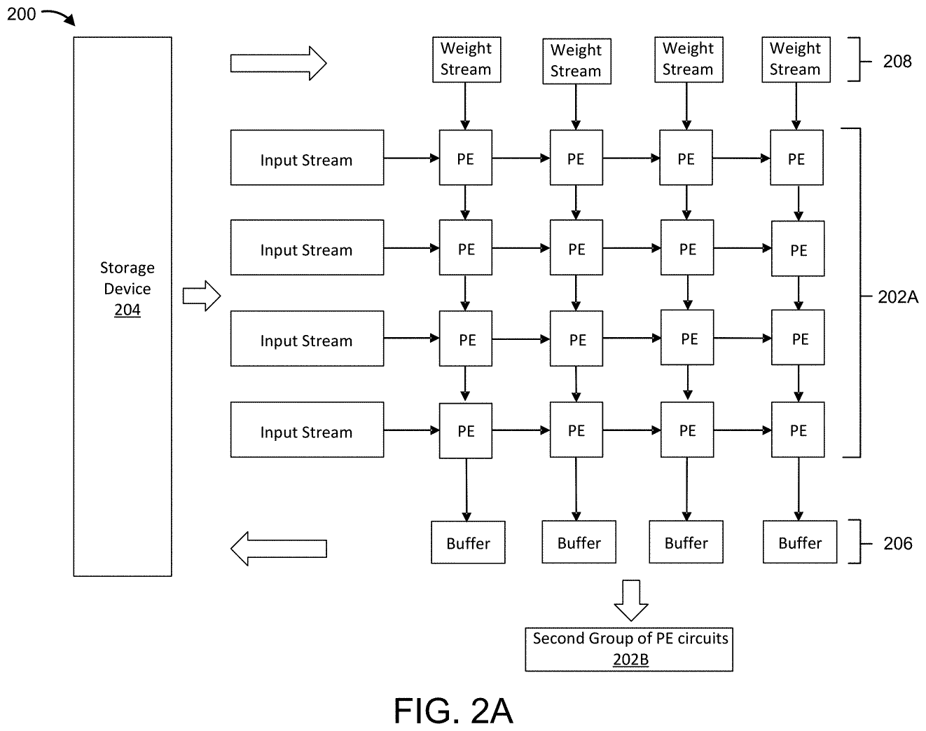

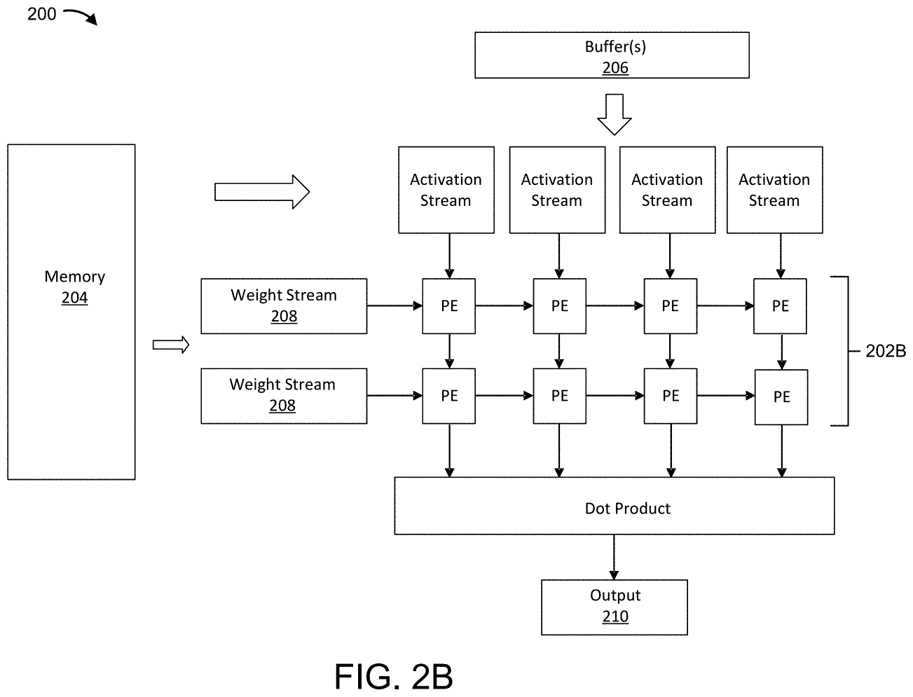

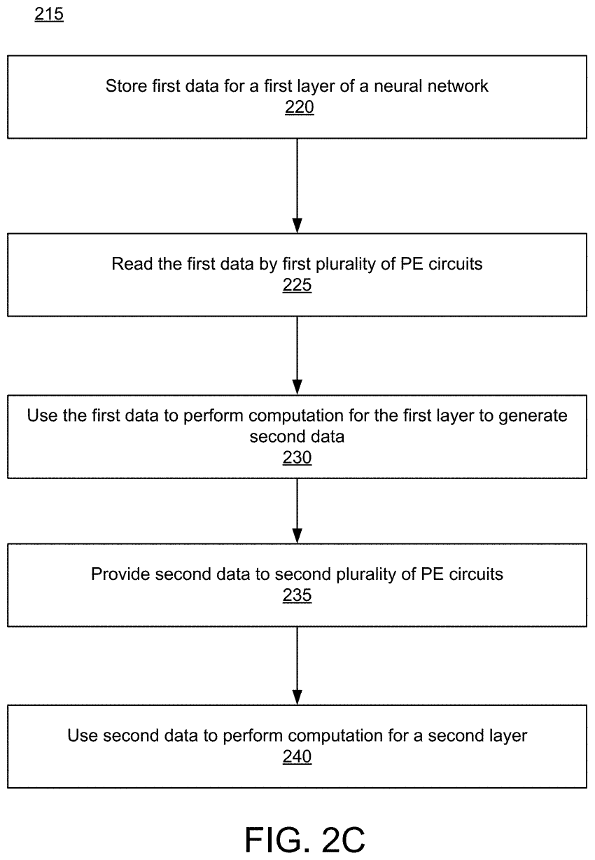

Referring now to FIG. 2A and FIG. 2B, depicted is a block diagram of a device 200 for pipelined parallelism to perform AI-related processing. At least some of the components depicted in FIG. 2A and FIG. 2B may be similar to those depicted in FIG. 1B and described above. For instance, the device 200 may be or include an AI Accelerator 108. The device 200 may include a plurality or array of processing element (PE) circuits 202, which may be similar or the same in some aspects to the PE circuit(s) 120 described above in Section A. Similarly, the device 200 may include and/or use a storage device 204, buffer(s) 206, and weights 208, which may be similar or the same in some aspects to storage device 124, buffer(s) 130, and weights 134, respectively, which were described above. As described in greater detail below, the storage device 204 may be configured to store data for a first layer of a neural network. The PE circuit(s) 202 may be configured to read the data from the storage device 204 and perform computation for the first layer of the neural network to generate data (e.g., output data, or activation data). The buffer(s) 206 may be configured to output, direct, convey, send and/or provide the generated data to other PE circuit(s) 202 (e.g., shown in FIG. 2B). Those other PE circuit(s) 202 may be configured to perform computation for a second (e.g., different or next) layer of the neural network using the generated data as input.

Each of the above-mentioned elements or components is implemented in hardware, or a combination of hardware and software. For instance, each of these elements or components can include any application, program, library, script, task, service, process or any type and form of executable instructions executing on hardware such as circuitry that can include digital and/or analog elements (e.g., one or more transistors, logic gates, registers, memory devices, resistive elements, conductive elements, capacitive elements).

In the example embodiment, the device 200 is shown to include a storage device 204 (e.g., memory). The storage device 204 may be or include any device, component, element, or subsystem of the device 200 designed or implemented to receive, store and/or provide access to data. The storage device 204 may store data by having data written to memory locations (identified by memory addresses) in the storage device 204. The data may subsequently be retrieved from the storage device 204 (e.g., by PE circuits 202 or other components of the device 200). In some implementations, the storage device 204 may include a Static Random Access Memory (SRAM) or any other type or form of memory, storage register or storage drive. The storage device 204 may be designed or implemented to store data for a neural network (e.g., data or information for various layers of the neural network, data or information for various nodes within respective layers of the neural network, etc.). For example, the data can include activation (or input) data or information, refined or updated data (e.g., weight information and/or bias information from a training phase for example, activation function information, and/or other parameters) for one or more neurons (or nodes) and/or layers of the neural network, which can be transferred or written to, and stored in the storage device 204. As described in greater detail below, the PE circuits 202 (of a first AI accelerator) may be configured to use the data from the storage device 204 to generate outputs from the neural network.

The device 200 is shown to include a plurality of PE circuits 202. In some embodiments, the device 200 may include a first group of PE circuits 202A and a second group of PE circuits 202B. In some embodiments, the first group of PE circuits 202A and second group of PE circuits 202B may be configured, arranged, incorporated, or otherwise formed on the same semiconductor device or electronics chip. Each PE circuit 202 may be similar in some respects to the PE circuits 120 described above. The PE circuits 202 may be designed or implemented to read input data from a data source and perform one or more computations (e.g., using weight data from the weight streams 208, bias information, parameters and/or kernel information) to generate corresponding data. The input data may be an input stream (e.g., received or read from the storage device 204), or an activation/input stream (e.g., from a previous layer or node of the neural network), and so forth. As one example, the first group of PE circuits 202A may be configured to read data from the storage device 204 (e.g., weight data 208) and perform computation using the input data, for a first layer of the neural network to generate outputs (e.g., activation/input data for a second layer of the neural network). The first group of PE circuits 202A may be configured to pass the generated output or activation data to the buffer(s) 206. The buffer(s) 206 may be configured to transmit, relay, queue, buffer, direct, provide, or otherwise output the activation data (e.g., as an activation stream) to the second group of PE circuits 202B.

While the first group of PE circuits 202A performs computations on subsequent input data (or input streams), the second group of PE circuits 202B may be configured to perform computations for the second layer of the neural network (in parallel) using the activation data received from the first group of PE circuits 202A (as described in greater detail below). Thus, rather than writing the generated data (e.g., generated by the first layer) from the buffer(s) 206 to the storage device 204 (e.g., for subsequent retrieval by the second group of PE circuits 202B), the first group of PE circuits 202A may be configured to provide the generated data to the buffer(s) 206 which, in turn, directly pass the generated data to the second group of PE circuits 202B. Such embodiments may reduce energy consumption by bypassing the read and/or write operations to the storage device 204 during processing for the neural network. Further, as the first and second group of PE circuits 202A, 202B perform multi-layer computations in parallel, improvements in overall processing throughput may be realized by such parallel computations for the respective layers of the neural network.

The PE circuits 202 may be configured to perform computation for at least one node of the neural network. For instance, and as described in greater detail above in Section A, the neural network can include an input layer and an output layer, of neurons or nodes, and one or more hidden layers (e.g., convolution layers, pooling layers, fully connected layers, and/or normalization layers). Each layer may include a plurality of neurons or nodes. Each node can receive input from some number of locations in the previous layer (e.g., input data or activation data, and so forth). In a fully connected layer, each neuron can receive input from every element of the previous layer. Each neuron in a neural network can compute an output value by applying some function to the input values coming from the receptive field in the previous layer. The function that is applied to the input values can be specified by a vector of weights and a bias (typically real numbers). The vector of weights and the bias can be called a filter and can represent some feature of the input.

In some embodiments, the first group of PE circuits 202A may be configured to perform computations for at least one node (e.g., of the first layer) of the neural network. The first group of PE circuits 202A may be configured to perform computations for each of the nodes of the first layer of the neural network. The first layer may include a plurality of nodes (neurons). At least one of the PE circuits 202 from the first group of PE circuits 202A may be configured to perform computations for all or a subset of the nodes from the first layer. In some embodiments, the first group of PE circuits 202A may be configured to perform computation for a single node for the first layer of the neural network. In certain embodiments, one of the PE circuits 202A may be configured to perform computations for a respective node from the first layer, while another PE circuit 202A may be configured to perform computations for a different node from the first layer (e.g., each PE circuit 202A from the first group 202A performs computations for a dedicated node of the first layer). Similarly, the second group of PE circuits 202B may be configured to perform computations for a second layer of the neural network (e.g., a subset of PE circuits 202B may perform computations for one node of the neural network, or a dedicated PE circuit 202B may perform computation for a corresponding node of the neural network, or all of the PE circuits 202B may perform computation for a single node of the neural network, and so forth).

In some embodiments, each of the layers of the neural network may include a corresponding group of PE circuits 202 (e.g., a first group of PE circuits 202A for a first layer, a second group of PE circuits 202B for a second layer, a third group of PE circuits 202 for a third layer, and so forth). In some embodiments, some of the PE circuits 202 (e.g., within the group of PE circuits 202A, 202B) may be dedicated to handle processing for specific nodes of the neural network. For instance, some of the PE circuits 202A may be assigned or mapped to node(s) within the first layer, while other PE circuits 202A may be assigned or mapped to node(s) within a third layer. In some embodiments, the first group of PE circuits 202A may perform processing for a first node (or a first subset of nodes) of a first layer during a first time window, generate first output(s) for the first node (or the first subset of nodes), and then perform processing for a second node (or a second subset of nodes) of the first layer during a second/subsequent time window, and generate second output(s) for the second node (or the second subset of nodes). The second group of PE circuits 202B may receive the first output(s) and perform processing for a first node (or a first subset of nodes) for a second layer of the neural network during the second time window, generate first output(s) for the first node (or the first subset of nodes) of the second layer, and then perform processing for a second node (or a second subset of nodes) of the second layer during a third time window, and generate second output(s) for the second node (or the second subset of nodes) of the second layer. In this regard, the neural network may include layers of one or more nodes, and the PE circuits 202 may be configured to perform both pipelined and parallel computations for the nodes and/or layers.

The buffers 206 may be configured to output generated data (e.g., received from the PE circuits 202). In some embodiments, the PE circuits 202 may transmit, deliver, pass, convey, direct or otherwise provide the generated data to the buffer 206 (e.g., directly by bypassing other PE circuits 202, or routed through other PE circuits 202). In some embodiments, the buffers 206 include sequential devices (e.g., registers or flip-flops) that are clocked and/or enabled to transfer, shift or output the generated data. For instance, the buffers 206 may be configured to hold data for a certain amount of time which may correspond to a clock period (e.g., provide the data as an output after a certain duration or amount of time). In some embodiments, the buffers 206 may be or include combinational logic that implements a repeater (or amplifier). As such, the buffers 206 may be configured to relay the data received by the buffer 206 to another circuitry or subsystem (e.g., to the second group of PE circuits 202B that forms a dot-product engine for instance). In these and other embodiments, the buffers 206 may be configured to output the generated data (e.g., generated by the first group of PE circuits 202A) as input to the second group of PE circuits 202B by bypassing any transfer of the second data into or out of the storage device 204. The buffers 206 may be configured or implemented with sufficient capacity to receive, buffer, queue, provide and/or output the generated data to the second group of PE circuits 202B.

In some embodiments, the second group of PE circuits 202B may be configured to generate data using the data received from the first group of PE circuits 202A (e.g., via the buffer 206). Specifically, as shown in FIG. 2B, the second group of PE circuits 202B may be configured to receive data from the first group of PE circuits 202A via the buffers 206. The second group of PE circuits 202B may receive the activation data (e.g., as an activation stream) from the buffers 206. The second group of PE circuits 202B may be configured to perform computations using the activation data and other data (e.g., weight stream 208 or other activation information as described above in Section A) from the storage device 204. The other activation information can include for instance, information about an activation function, bias information, kernel information, and/or parameter(s) 128. Similar to the first group of PE circuits 202A, the second group of PE circuits 202B may be configured to receive and use the activation data to generate other data (e.g., output data, or activation data for a third layer of the neural network, etc.). In some embodiments, the second group of PE circuits 202B may be configured to store the generated data to the storage device 206 (e.g., for subsequent use in computation(s) for another layer of the neural network, for instance). In some embodiments, the device 200 may include an additional group of buffers 206 configured to receive the data generated by the second group of PE circuits 202B, and to transmit, deliver, provide, or otherwise output the data to a third group of PE circuits 202.

In some embodiments, the first group of PE circuits 202A may be configured to perform one function (e.g., an activation function) for a layer of the neural network and the second group of PE circuits 202B may be configured to perform another function for another layer of the neural network. For instance, the first group of PE circuits 202A may be configured to perform a convolution operation using the first data. The convolution operation can be or include a type of deep, feed-forward artificial neural network configured to analyze visual imagery, audio information, and/or any other type or form of input data. The convolution operation can include multilayer perceptrons designed to use minimal preprocessing. The convolution operation can include or be referred to as shift invariant or space invariant artificial neural networks, based on their shared-weights architecture and translation invariance characteristics. The first group of PE circuits 202A may be configured to perform the convolution operations for at least one node and/or one layer of the neural network. The second group of PE circuits 202B may be configured to perform dot-product operations using data generated by the first group of PE circuits 202A (e.g., for the same node(s) and/or layer, or for different node(s) and/or layer of the neural network). The second group of PE circuits 202B may be configured to perform dot-product operations to form an output 210 for the neural network.

According to the embodiments described herein, the device 200 may be configured to support pipelined parallelism of a neural network where operations for two (or more) layers of the neural network can be run in a pipeline and/or in parallel. The device 200 may be configured such that the output from one layer of the neural network is fed directly into the next layer via one or more buffers, effectively bypassing read and/or write operations to memory. As such, energy savings can be realized by bypassing the memory-related read and/or write operations, as well as via reduction in computational costs by using smaller groups of PEs (e.g., to perform group convolutions). Further, processing throughput can be improved through parallel computations by multiple groups of PE circuits 202A, 202B.

Referring now to FIG. 2C, depicted is a flow diagram for a method 215 for pipelined parallelism to perform AI related processing, e.g., for nodes across multiple layers of a neural network. The functionalities of method 215 may be implemented using, or performed by, the components described in FIGS. 1A-2B, such as the AI Accelerator 108 and/or device 200. In brief overview, the memory can store first data for a first layer of a neural network (220). A first plurality of PE circuits can read the first data (225). The first plurality of PE circuits use the first data to perform computation for the first layer to generate second data (230). A plurality of buffers can provide the second data to a second plurality of PE circuits (235). The second plurality of PE circuits can use the second data to perform computation for a second layer of the neural network (240).

In further detail of (220), and in some embodiments, the method 215 includes storing first data for a first layer of a neural network in memory. The first data may be or include weight or activation information for the first layer of the neural network. The memory or storage device 126 may provide the activation data in a plurality of input streams 132, and the activation data may be include at least a portion of input data 110 for an AI accelerator 108 for instance. In some embodiments, the method 215 may include storing first and second data for a first and second layer of the neural network. The first data may be specific to the respective layers of the neural network. In some embodiments, the first and second data may be specific to nodes of the respective layers of the neural network. The memory (or storage device 126) may receive and hold the first data for subsequent retrieval by one or more PEs. In some embodiments, the first data (e.g., weights, activation function) may be trained or refined over time (e.g., during a training stage to refine the weights and/or activation information) to improve the output data for one or more nodes and/or layers of a neural network.

In further detail of (225), and in some embodiments, the method 215 includes reading the first data. In some embodiments, the first plurality of PE circuits (of first circuitry or a first AI accelerator 108)) reads the first data from the memory, for one or more nodes of a first layer of the neural network. In some implementations, each respective PE circuit may read or access respective data from the memory. For instance, a PE circuit of the first plurality of PE circuits may be dedicated, assigned and/or mapped to a particular node, and each respective PE circuit may access the memory to retrieve, access, or otherwise read weight and/or activation data from the memory corresponding to the PE circuit. The PE circuit may access the memory to read the first data for performing a computation for the first layer, as described in greater detail below.

In further detail of (230), and in some embodiments, the method 215 includes using the first data to perform computation for the first layer to generate second data (e.g., as inputs to second circuitry). In some embodiments, the first plurality of PE circuits uses the first data to perform computation (e.g., convolution operations) for the first layer of the neural network to generate second data. The first plurality of PE circuits may perform computation on an input stream using (e.g., kernel or weight information from) the first data. The first plurality of PE circuits may perform computation on the input stream, using the input stream and the first data to generate a corresponding output (e.g., that can be used as activation data for a second layer of the neural network). In some embodiments, the first plurality of PE circuits may perform a convolution operation using (e.g., kernel information from) the first data (and the input stream). The first plurality of PE circuits may perform a convolution operation to generate the activation data (or second data) for the second layer.

In further detail of (235), and in some embodiments, the method 215 includes providing the second data to a second plurality of PE circuits. In some embodiments, a plurality of buffers of the first plurality of PE circuits provide the generated second data as input to a second plurality of PE circuits, to perform computation for a second layer of the neural network. The buffers may pass, convey or output the generated second data (e.g., at step (230)) to the second circuitry to perform computation or processing for the second layer of the neural network. The buffers may be clocked and/or enabled to pass or output the generated second data after a duration of time. In some embodiments, the buffers may (asynchronously, or synchronously in relation to a clock signal) pass the generated second data responsive to receiving the data from the first plurality of PE circuits. In each of these embodiments, the plurality of buffers may provide the generated second data as an input to the second circuitry or second plurality of PE circuits by bypassing any transfer of the second data into or out of the memory (e.g., storage device 126).

In further detail of (240), and in some embodiments, the method 215 includes using the second data to perform computation for a second layer of the neural network. In some embodiments, the second plurality of PE circuits uses the second data to perform computation for the second layer of the neural network. Similar to step (230), the second plurality of PE circuits may use data (e.g., weights) from the memory and the second data (e.g., from the buffers) to perform computation for the second layer of the neural network. The second data may include weight, bias and/or activation function information for the second layer of the neural network. In some embodiments, step (230) and step (240) may be performed in sequence in a pipeline, or at substantially the same time (e.g., in parallel). For example, the first plurality of PE circuits may perform computation for at least one node of (the first/second/third layer of) the neural network while the second plurality of PE circuits may be performing computation for at least another node of the second layer of the neural network. In some implementations, the at least one node may be from a third layer (e.g., a layer downstream from the second layer of the neural network) or from the first layer (e.g., upstream from the second layer of the neural network). In some embodiments, the second plurality of PE circuits may comprise a dot-product engine that can perform dot-product operations using the second data. The second plurality of PE circuits may perform dot-product operations on the second data received by the buffers to generate an output.

In some embodiments, the second plurality of PE circuits may generate third data using the second data. The second plurality of PE circuits may store the third data in memory (e.g., by performing a write operation to the memory). The third data may be stored in memory for subsequent use by another layer of the neural network, or for subsequent use by a device or component external to the device. The second plurality of PE circuits may provide the third data to a plurality of buffers corresponding to the second plurality of PE circuits which, in turn, can provide the third data to a third plurality of PE circuits (e.g., similar to step (235)). The third plurality of PE circuits may perform computations using the third data (and other data from the memory) while the second plurality of PE circuits can perform computations (in parallel with the third plurality of PE circuits) using data received from the buffers corresponding to the first plurality of PE circuits, and while the first plurality of PE circuits perform computations on an input stream of data (in parallel with the second and third pluralities of PE circuits). As such, the first, second, and/or third pluralities of PE circuits may perform computations in parallel. Further, buffers for the first plurality of PE circuits may provide activation data (e.g., generated from performing computations at the first layer) to the second plurality of PE circuits, and the buffers for the second plurality of PE circuits may provide corresponding activation data (e.g., generated from performing computations on the activation data at the second layer) to the third plurality of PE circuits. Such buffers may thus bypass read and write operations of the activation data to the memory.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of” ‘A’ and ‘B’ can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device comprising:
memory configured to store first data for a first layer of a neural network;
first circuitry comprising a first plurality of processing element (PE) circuits configured to read the first data from the memory and to perform computation for the first layer of the neural network using the first data to generate second data, the first circuitry further comprising a plurality of buffers configured to output the generated second data as input to second circuitry to perform computation for a second layer of the neural network; and
the second circuitry comprising a second plurality of PE circuits configured to perform computation for the second layer of the neural network using the second data.

2. The device of claim 1, wherein the first plurality of PE circuits is configured to perform computation for at least one node of the neural network while the second plurality of PE circuits is performing computation for the second layer of the neural network.

3. The device of claim 2, wherein the at least one node is from a third layer of the neural network or from the first layer of the neural network.

4. The device of claim 1, wherein the plurality of buffers is configured to output the generated second data as input to the second circuitry by bypassing any transfer of the second data into or out of the memory.

5. The device of claim 1, wherein the second plurality of PE circuits is further configured to use the second data to generate third data.

6. The device of claim 5, wherein the second plurality of PE circuits is further configured to store the generated third data to the memory.

7. The device of claim 5, wherein the second circuitry further comprises a plurality of buffers configured to output the generated third data as input to third circuitry.

8. The device of claim 1, wherein the first data comprises at least one of weight or activation information for the first layer of the neural network, and the second data comprises at least one of weight or activation information for the second layer of the neural network.

9. The device of claim 1, wherein the first plurality of PE circuits is configured to perform a convolution operation using the first data, and the second plurality of PE circuits is configured to perform dot-product operations using the second data.

10. The device of claim 1, wherein the first circuitry and the second circuitry are formed on a same semiconductor device.

11. The device of claim 1, wherein the plurality of buffers is configured with sufficient capacity to buffer the generated second data and output the generated second data to the second circuitry.

12. A method comprising:
storing first data for a first layer of a neural network in a memory;
reading, by a first plurality of processing element (PE) circuits, the first data from the memory;
using, by the first plurality of PE circuits, the first data to perform computation for the first layer of the neural network to generate second data;
providing, by a plurality of buffers of the first plurality of PE circuits, the generated second data as input to a second plurality of PE circuits to perform computation for a second layer of the neural network; and
using, by the second plurality of PE circuits, the second data to perform computation for the second layer of the neural network.

13. The method of claim 12, further comprising performing, by the first plurality of PE circuits, computation for at least one node of the neural network while the second plurality of PE circuits is performing computation for the second layer of the neural network.

14. The method of claim 13, wherein the at least one node is from a third layer of the neural network or from the first layer of the neural network.

15. The method of claim 12, comprising providing, by the plurality of buffers, the generated second data as input to the second plurality of PE circuits by bypassing any transfer of the second data into or out of the memory.

16. The method of claim 12, further comprising generating, by the second plurality of PE circuits, third data using the second data.

17. The method of claim 16, further comprising storing, by the second plurality of PE circuits, the generated third data to the memory.

18. The method of claim 16, further comprising providing, by a plurality of buffers corresponding to the second plurality of PE circuits, the generated third data as input to third circuitry.

19. The method of claim 12, wherein the first data comprises at least one of weight or activation information for the first layer of the neural network, and the second data comprises at least one of weight or activation information for the second layer of the neural network.

20. The method of claim 12, comprising performing, by the first plurality of PE circuits, a convolution operation using the first data, and performing, by the second plurality of PE circuits, dot-product operations using the second data.
